(19) United States
(12) Patent Application Publication
(10) Pub. No.: US 2025/0296163 A1
(43) Pub. Date: Sep. 25, 2025

(54) Band Saw Stand

(71) Applicant: Harbor Freight Tools USA, Inc., Calabasas, CA (US)

(72) Inventor: Robert Clinker, Simi Valley, CA (US)

(21) Appl. No.: 18/615,550

(22) Filed: Mar. 25, 2024

(51) Int. Cl. B23D 55/02; B23D 53/00; B23D 53/12

(52) U.S. Cl. CPC B23D 55/02; B23D 53/006; B23D 53/12

(57) ABSTRACT

A band saw stand includes a base and an arm rotatably coupled to the base. The arm includes an opening that receives at least a first band saw having a mounting portion and a second band saw having a different mounting portion. The band saw stand is further configured to couple to the mounting portion of the first band saw and the different mounting portion of the second band saw.

### BACKGROUND

The present disclosure relates generally to band saw stands for portable band saws. Known band saw stands may allow mounting with only one type of band saw. Thus it may be desirable for a band saw stand to accommodate multiple different types of band saws.

### SUMMARY

A band saw stand disclosed, substantially as illustrated by and described in connection with at least one of the figures, as set forth more completely in the claims.

According to embodiments, a band saw stand includes: a base; and an arm rotatably coupled to the base, wherein the arm includes an opening configured to receive at least a first band saw having a mounting portion and a second band saw having a different mounting portion, wherein the band saw is further configured to couple to at least the mounting portion of the first band saw and the different mounting portion of the second band saw. The base may be configured to be operable in a horizontal orientation and a vertical orientation. The band saw stand may further include a first bracket configured to couple to the arm and configured to move with respect to the arm, wherein the first bracket is configured to couple to the mounting portion of the first band saw. The band saw stand may further include a second bracket configured to couple to the arm and configured to move with respect to the arm, wherein the second bracket is configured to couple to the different mounting portion of the second band saw. The band saw stand may further include a trigger bar coupled to the arm, wherein the trigger bar is adjustable into at least a first orientation and a second orientation, wherein, when in the first orientation, the trigger bar is configured to interact with a trigger of the first band saw, and wherein, when in the second orientation, the trigger bar is configured to interact with a trigger of the second band saw. The band saw stand may further include an adjustable fence configured to adjust a cut angle and movably coupled to the base. The band saw stand may further include a strut coupled to the arm and the base, wherein one end of the strut is movable into a plurality of locations to adjust an angle of the strut with respect to the base.

According to embodiments, a band saw stand includes: a base configured to mount to a surface; an arm rotatably coupled to the base, wherein the arm includes an upper portion defining a length and a width, wherein the upper portion includes at least one engagement feature, wherein the upper portion defines an opening sized to receive portions of different band saws, wherein the band saws have different mounting portions; and a bracket configured to couple with the arm and move with respect to the arm via the at least one engagement feature, wherein the bracket is configured to couple to a mounting portion of at least one of the band saws. The base may be configured to be operable in a horizontal orientation and a vertical orientation. The at least one engagement feature of the arm may include at least one aperture extending along the length dimension of the upper portion of the arm, wherein the bracket is securable to the upper portion of the arm via the at least one engagement feature at a plurality of locations along the length of the at least one aperture. The band saw stand may include a plurality of brackets, wherein each bracket is configured to couple to separate ones of the different mounting portions of the band saws. The band saw stand may further include a trigger bar coupled to the upper portion of the arm, wherein the trigger bar is configured to be adjustable in a plurality of orientations to interact with triggers of the band saws. The band saw stand may further include adjustable fence configured to adjust a cut angle and movably coupled to the base. The band saw stand may further include a strut coupled to the arm and the base, wherein one end of the strut is movable into a plurality of locations to adjust an angle of the strut with respect to the base.

According to embodiments, a band saw stand includes: a base; and an arm rotatably coupled to the base, wherein the arm includes a mounting plate, wherein the arm includes an opening to receive a portable band saw, wherein the band saw stand is configurable in a horizontal orientation when the base is resting on a horizontal surface, and wherein the band saw stand is configurable in a vertical orientation when mounting plate is fastened to a horizontal surface. The band saw stand may include first bracket may be configured to couple to the arm and configured to move with respect to the arm, wherein the first bracket is configured to couple to a mounting portion of a first band saw. The band saw stand may include a second bracket configured to couple to the arm and configured to move with respect to the arm, wherein the second bracket is configured to couple to a different mounting portion of a second band saw. the band saw stand may further include a trigger bar coupled to the arm, wherein the trigger bar is adjustable into at least a first orientation and a second orientation, wherein, when in the first orientation, the trigger bar is configured to interact with a trigger of a first band saw, and wherein, when in the second orientation, the trigger bar is configured to interact with a trigger of a second band saw. The band saw stand may further include a table plate configured to couple to the arm. The band saw stand may further include a strut coupled to the arm and the base, wherein one end of the strut is movable into a plurality of locations to adjust an angle of the strut with respect to the base.

### BRIEF DESCRIPTION OF SEVERAL VIEWS OF THE DRAWINGS

The following is a brief description of the drawings pertaining to the present disclosure, which will be discussed in more detail in the detailed description section below.

FIG. 1 illustrates a band saw.

FIG. 2A illustrates a left-side perspective view of a band saw stand in an open, horizontal orientation, according to embodiments.

FIG. 2B illustrates a left-side perspective view of a band saw stand in a closed, horizontal orientation, according to embodiments.

FIG. 3 illustrates a right-side perspective view of the band saw stand in a closed, horizontal orientation, according to embodiments.

FIG. 4 illustrates a bracket mounting to the band saw, according to embodiments.

FIG. 5 illustrates the band saw mounted in the band saw stand in a vertical orientation, according to embodiments.

FIGS. 6A, 6B, 6C, and 6D illustrate different examples of the bracket, according to embodiments.

FIG. 7 illustrates a coupling arrangement to enable rotatable coupling between an arm and a base of the band saw stand, according to embodiments.

FIG. 8 illustrates a right-side perspective view of the band saw mounted in the band saw stand in the closed, horizontal orientation, according to embodiments.

FIG. 9 illustrates an exploded view of the band saw, according to embodiments.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein.

### DETAILED DESCRIPTION

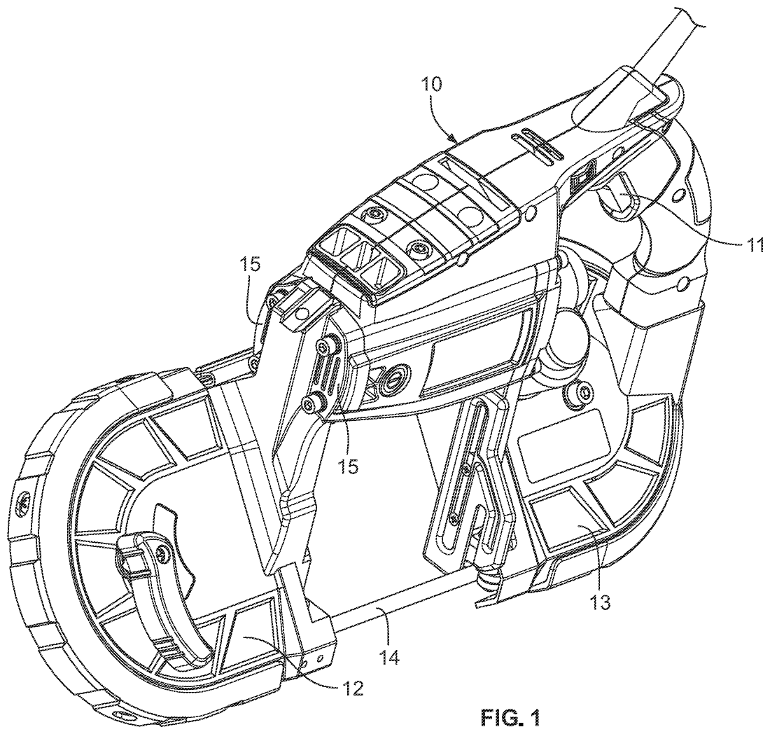

FIG. 1 illustrates a band saw 10. As shown, the band saw 10 is portable and corded. The band saw 10 may be battery-powered (DC) instead of corded (AC). The band saw 10 includes a front wheel case 12 and a rear wheel case 13. A trigger 11 activates the band saw 10, thereby causing a blade 14 to move. The trigger 11 may be a momentary contact switch that causes the blade 14 to move when activated and causes the blade 14 to stop when released. The band saw 10 includes a mounting portion 15 to which couples to a band saw stand 100, see FIG. 1. The mounting portion 15 includes at least one aperture to receive fasteners, such as bolts, screws, etc. The aperture(s) on the mounting portion 15 may be threaded to accept the threads of a mounting bolt, screw, or any other type of fastener capable of securing the band saw 10 to the band saw stand 100. The mounting portion 15 will be further discussed in context of a bracket 130 below.

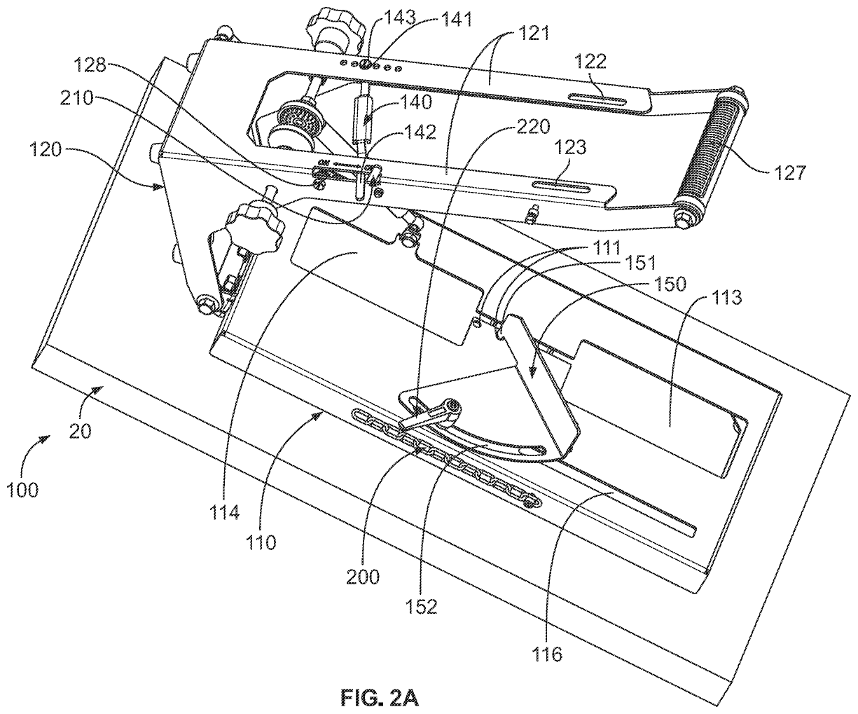

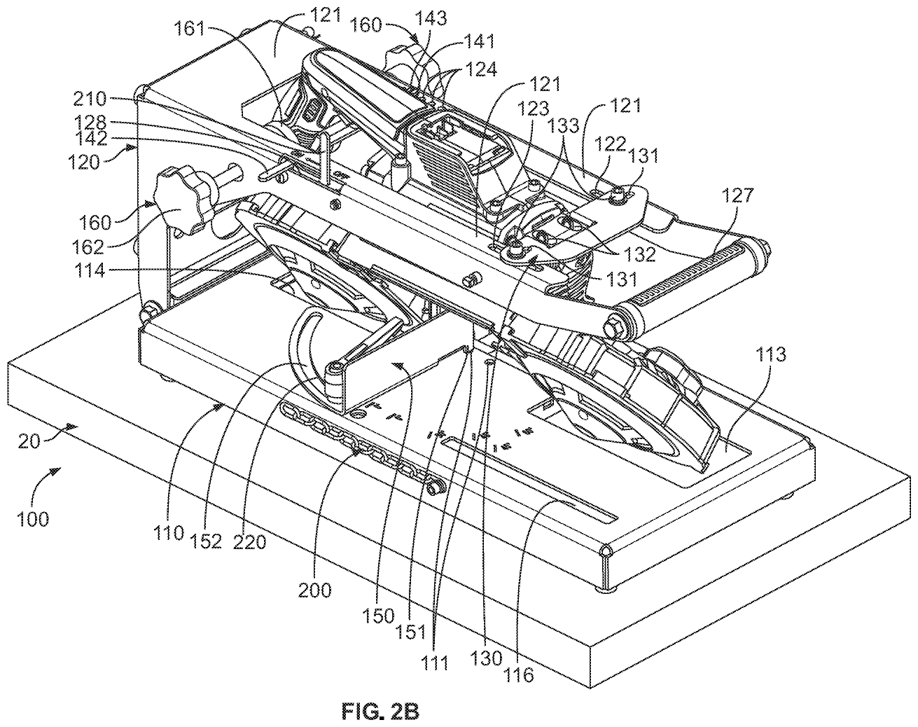

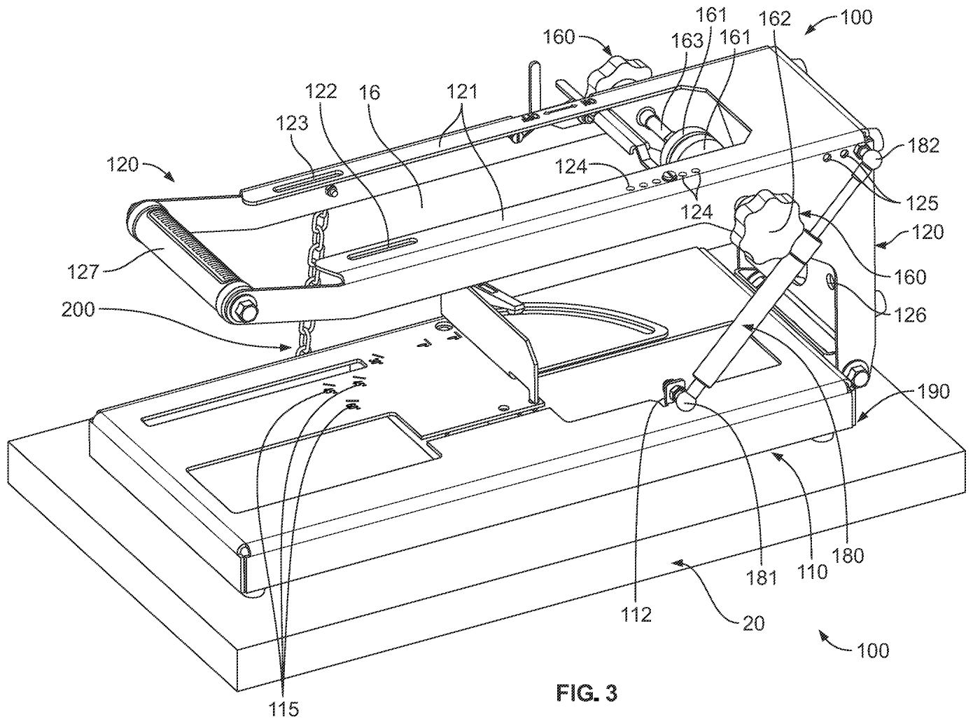

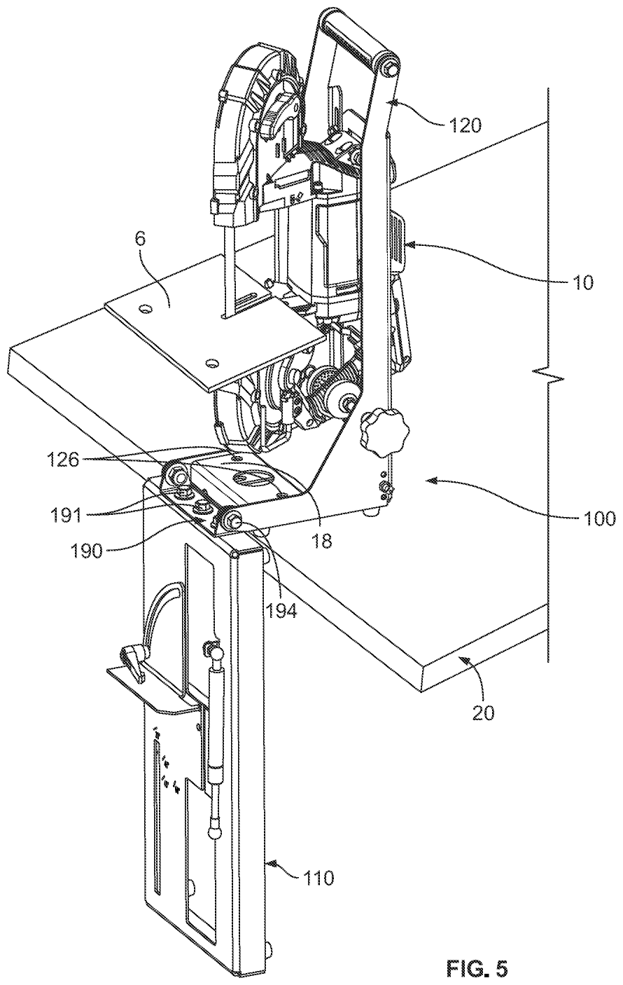

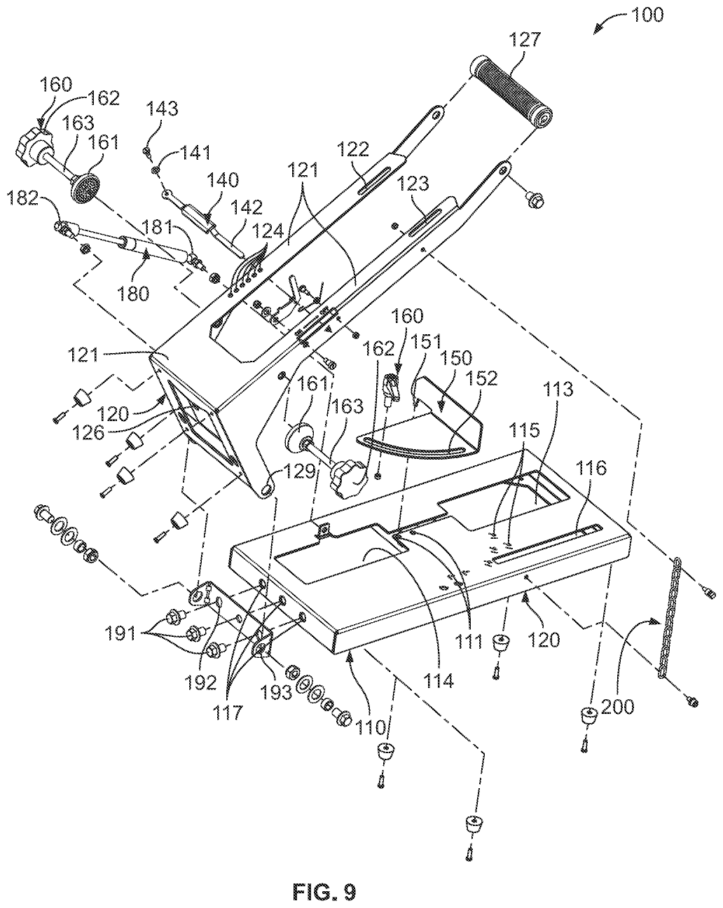

FIGS. 2A and 2B illustrate left-side perspective views of the band saw stand 100 in an open horizontal orientation and a closed horizontal orientation, respectively, according to embodiments. FIG. 3 illustrates a right-side perspective view of the band saw stand 100 in a closed, horizontal orientation, according to embodiments. FIG. 9 illustrates an exploded view of the band saw stand 100, according to embodiments. The band saw stand 100 mounts to the selected band saw 10. The band saw stand 100 may receive differently-configured band saws having different mounting portions 15. The band saw stand 100 includes a base 110 and an arm 120. The arm 120 includes an upper arm portion 121 and a handle 127. The upper arm portion 121 of the arm 120 and the handle 127 may define a band saw opening 16 that receives different types and/or configurations of band saws 10 each having different mounting portions 15. The band saw opening 16 facilitates the band saw stand 100 to be a single device that can accommodate different types of band saws 10 and/or configurations of band saws 10 having different configured mounting portions 15. The band saw stand 100 is configured to permit operation of the band saw 10 in two different orientations-horizontal and vertical. In the horizontal orientation, the base 110 rests on a horizontal surface 20 (e.g., rests with or without being mounted or coupled to the horizontal surface 20), such as a work bench. The horizontal orientation is shown in FIGS. 2A, 2B, and 3. In the vertical orientation, as shown in FIG. 5, the arm 120 secures to the horizontal surface 20.

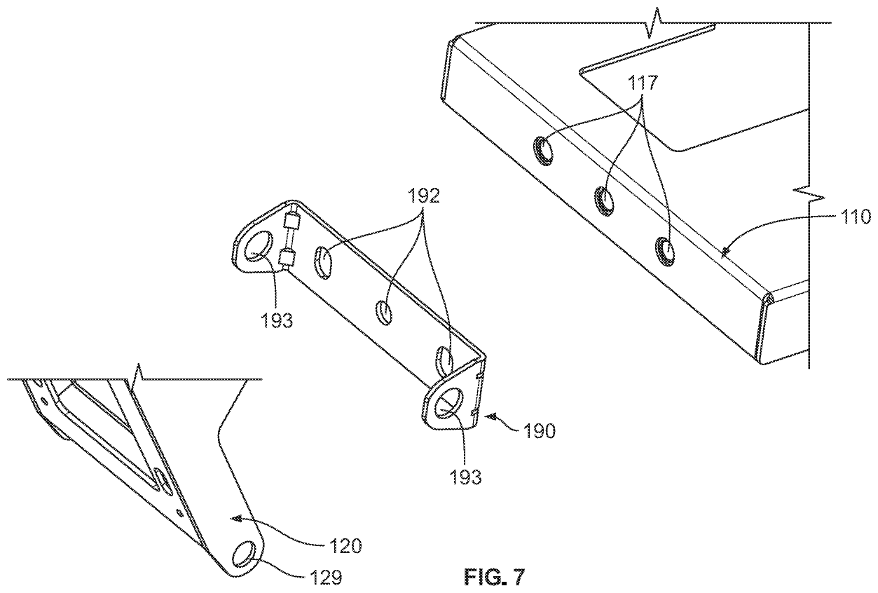

The base 110 and the arm 120 are rotatably coupled with each other, as can be seen in FIGS. 2A, 2B, 3, and 5. According to an embodiment, rotatable coupling between the base 110 and the arm 120 is achieved with an additional component, a coupling plate 190. As shown in FIG. 5 and FIG. 7, a coupling plate 190 couples to the base 110 with base fasteners 191 (e.g., with bolts). The coupling plate 190 may include at least one coupling plate aperture 192 and the base 110 may include at least one base aperture 117. The base apertures 117 in base 110 correspond with the coupling plate apertures 192 in the coupling plate 190. Some or all of these apertures may be threaded. Base fasteners 191 may secure the coupling plate 190 to the base 110 through the coupling plate apertures 192 and base apertures 117, either through complimentary threads and/or securing by another fastener, such as nuts, or any other type of fastener able to secure the coupling plate 190 to the base 110. As further shown in FIG. 5 and FIG. 7, the coupling plate 190 connects with the arm 120, through a pair of lateral apertures 193. The arm 120 includes a pair of arm apertures 129 in the arm 120 corresponding with the lateral apertures 193 on the coupling plate 190 and receive arm fasteners 194 to enable rotatable coupling between the arm 120 and the base 110 (as well as the coupling plate 190). The arm fasteners 194 coupling the arm 120 to the coupling plate 190 may be the same type of fasteners as the base fasteners 191 coupling the coupling plate 190 to the base 110. In other embodiments, the base fasteners 191 coupling the base 110 to the coupling plate 190 and the arm fasteners 194 coupling the coupling plate 190 to the arm 120 may be different types or sizes of fasteners from each other. For example, both the base fasteners 191 and the arm fasteners 194 may be bolts extending through the lateral apertures 193, arm apertures 129, base apertures 117, and coupling plate apertures 192, secured with a type of nut, not shown. In other examples, the base fasteners 191 may be a bolt secured with a type of nut and the arm fasteners may be a type of screw.

As shown in FIG. 3, a strut 180 (e.g., gas strut) includes a first end 181 and a second end 182. The first end 181 may couple to the base 110 and the second end 182 may couple to the arm 120. The base 110 includes a strut coupling feature 112 (e.g., an aperture through which a fastener such as a bolt can be inserted), at which the first end 181 of the strut 180 can couple with the base 110. The arm 120 may include a plurality of strut coupling apertures 125, through which a portion of the second end 182 may be inserted. The second end 182 of the strut 180 can couple with the arm 120 by receiving a portion of the second end 182 in one of the strut coupling apertures 125. By coupling the strut 180 at different coupling apertures 125 of the arm 120, the angle of the strut 180 may be adjusted with respect to the base 110 and the arm 120. It may be beneficial to adjust the angle of the strut 180 to adjust how the band saw stand 100 can be placed into the closed position and then released into the open position. The strut 180 not only allows the operator to adjust the opening, the various strut 180 positions also determine how much assistance the strut 180 gives when raising and lowering the handle 127. For example, when the second end 182 of the strut 180 is placed in the coupling aperture 125 closest to the handle 127, the strut 180 provides the user with more assistance when raising and lowering the handle 127 than when the second end 182 of the strut 180 is placed in the coupling aperture 125 furthest away from the handle 127.

The strut 180 tends to force the upper arm portion 121 away from the base 110 to put the band saw stand 100 in an open position, as shown in FIG. 2. During non-operational periods of the band saw 10, an operator may lift the handle 127 by pushing it in an upward direction, the strut 180 will force the upper arm portion 121 away from the base 110, thereby placing the band saw stand 100 in the open position. The operator may put the band saw stand 100 in the closed position by pulling the handle 127 in a downward direction. The handle 127 permits the operator to control the angle of the arm 120 with respect to the base 110 when the band saw stand 100 is in the horizontal orientation, thereby enabling the operator to cut a work piece with the blade 14 of the band saw 10. A lock 200 may be provided to maintain the band saw stand 100 in the closed position. The lock 200 may be fixedly coupled to the base 110 and selectively couplable to the upper arm portion 121 (or vice versa) to selectively maintain the closed position of the band saw stand 100. The lock 200 keeps the upper arm portion 121 and the base 110 from spreading apart, as shown in FIG. 3. In the exemplary embodiment the lock 200 may be a metal chain extending from the base 110 to the upper arm portion 121. In alternative embodiments, the lock 200 may be a strap made of various materials or another type of latching mechanism prohibiting separation between the upper arm portion 121 and the base 110 during periods of use, when then lock 200 is extending from the upper arm portion 121 to the base 110.

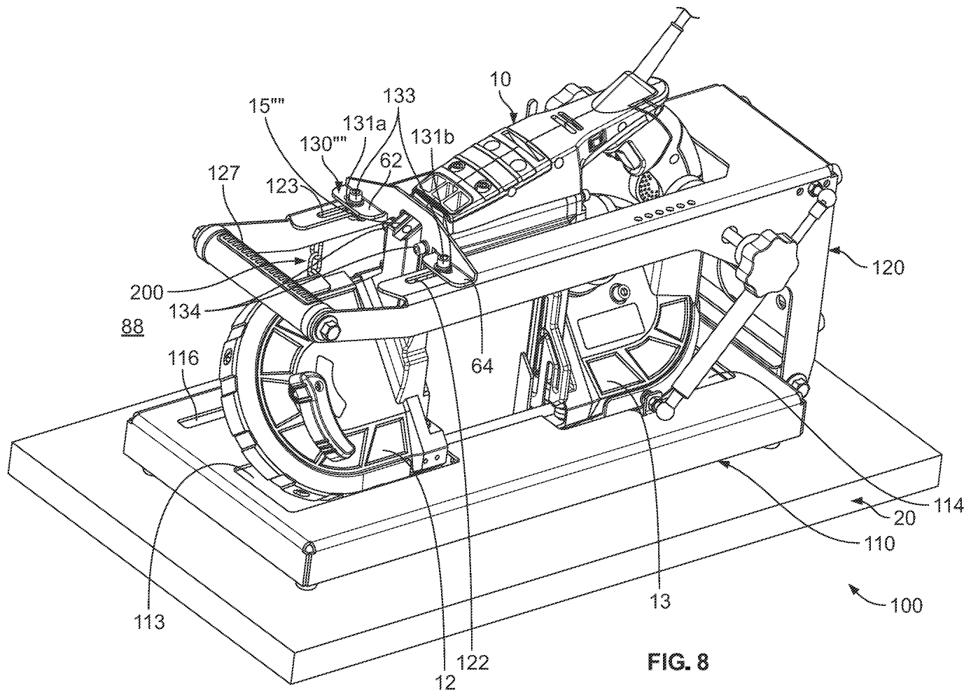

As shown in FIG. 2A, FIG. 2B, and FIG. 3, the base 110 includes a fence coupling feature 111, the strut coupling feature 112, a front wheel cutout 113, a rear wheel cutout 114, fence angle markings 115, and a clamp engagement feature 116. As further shown in FIG. 8, when the band saw stand 100 is in the closed position in a horizontal orientation, the front wheel cutout 113 receives the front wheel case 12 of the band saw 10. Further, the rear wheel cutout 114 receives the rear wheel case 13 of the band saw 10. The clamp engagement feature 116 permits a clamp (not shown) to be coupled to the base 110, such that the clamp can stabilize a work piece that is being cut by the band saw 10. The clamp engagement feature 116 allows the clamp to be located at various locations along the base 110, and is shown in this embodiment as an elongated slot.

As shown in FIGS. 2A, FIG. 2B and FIG. 3, the fence coupling feature 111 of the base 110 couples with a pivot 151 of a fence 150. The pivot portion 151 extends away from the fence 150 and configured to be inserted into the fence coupling feature 111. The fence coupling feature 111 may be an aperture that receives the pivot 151. The fence coupling feature 111 permits the fence 150 to rotate about the pivot 151. Thus, the fence 150 can be positioned at different angles with respect to the base 110. The base 110 may have two or more fence coupling features 111 to provide two locations for the fence 150 to rotate about the pivot 151. The location of the pivot 151 is dependent on which fence coupling feature 111 is being used to couple the fence 150 to the base 110. Angle markings 115 may be provided on the base 110 to indicate to the operator the angle between the fence 150 and the blade 14 of the band saw 10. Further facilitating the rotation of the fence 150, a fence adjustment slot 152 receives a fence tightener 220 at a plurality of positions along the fence adjustment slot 152. The fence tightener 220 engages with the base 110 and selectively stabilizes the fence 150 by clamping down on the fence 150 and base 110, thereby selectively permitting or inhibiting rotation of the fence 150.

As shown in FIG. 2A, FIG. 2B, and FIG. 3, the upper arm portion 121 includes a first engagement feature 122, a second engagement feature 123, a trigger coupling feature 124, the strut coupling feature 125 (discussed above), and the handle 127.

As shown in FIG. 5, the arm 120 includes a back plate 18. The back plate 18 includes at least one mounting hole 126. In the exemplary embodiment, there are two mounting holes 126. In alternative embodiments, there may only be one mounting hole 126 or there may be more than two mounting holes 126. The mounting hole(s) 126 may each receive a work surface fastener, such as a screw, not shown, to mount the back plate 18 of the arm 120 to the horizontal surface 20 when the band saw stand 100 is operated in the vertical orientation. Securely mounting the arm 120 to the horizontal surface 20 in the vertical orientation may allow for larger work pieces to be used with reduced risk of the band saw stand 100 being knocked over, jostled, or damaged. Additionally, securing the arm 120 to the horizontal work surface 20 enhances the experience of the operator because the operator does not need to hold on to any portion of the band saw stand 100 or the band saw 10 when using the band saw stand 100 in the vertical orientation. By securing the back plate 18 of the arm 120 with work surface fasteners to the horizontal work surface 20, the operator may also remove the base 110 from the band saw stand 100 and still be able to operate the band saw 10 in the vertical orientation. The vertical orientation of the band saw stand 100 has a smaller footprint, which is even smaller without the base 110. The handle 127 permits the operator to control the angle of the arm 120 with respect to the base 110 when the band saw stand 100 is in the horizontal orientation, thereby enabling the operator to cut a work piece with the blade 14 of the band saw 10.

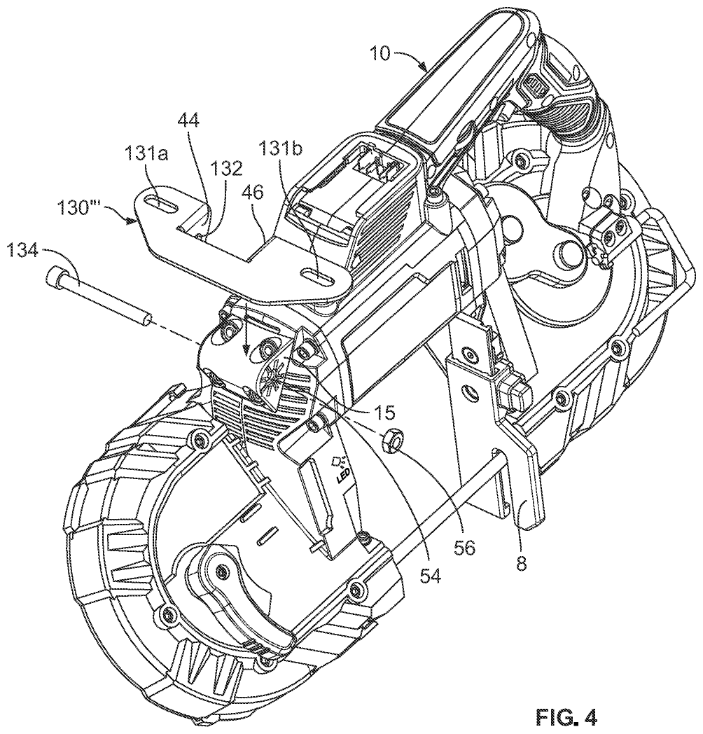

As shown in FIG. 3 and FIG. 4, the first engagement feature 122 (e.g., an aperture, such as an elongated aperture along the length of the upper arm portion 121 of the arm 120) and/or the second engagement feature 123 (e.g., an aperture, such as an elongated aperture along the length of the upper arm portion 121 of the arm 120) may facilitate coupling of the bracket 130 to the upper arm portion 121 of the arm 120. The bracket 130 includes a first arm coupling feature 131a, a second arm coupling feature 131b and at least one saw coupling feature 132. The first arm coupling feature 131a, e.g., an aperture, facilitates coupling of the bracket 130 with the first engagement feature 122 of the upper arm portion 121 of the arm 120. The second arm coupling feature 131b, e.g., an aperture, facilitates coupling of the bracket 130 with the second engagement feature 123 of the upper arm portion 121 of the arm 120. One or more bracket fasteners 133 (e.g., bolts and nuts) may be used to couple the bracket 130 to the upper arm portion 121 of the arm 120 via the first arm coupling feature 131a with the first engagement feature 122 of the arm 120 and the second arm coupling feature 131b with the second engagement feature 123 of the arm 120. The bracket 130 may be fixed to the arm 120, such that the bracket 130 does not move with respect to the arm 120. The bracket 130 may be selectively secured via bracket fasteners 133 at different locations on the upper arm portion 121 of the arm 120, such as at different locations along the length and/or width of the upper arm portion 121 along the length of the first engagement feature 122 and/or the second engagement feature 123. Other techniques are possible for selectively coupling the bracket 130 at different locations along the arm 120, such as a track and rail configuration (e.g., rail(s) on the bracket 130 and tracks on the arm 120).

The bracket 130 further couples with the band saw 10 selected by the operator. The band saw 10 includes the mounting portion 15 via which the bracket 130 couples. The saw coupling feature(s) 132 of the bracket 130 also facilitate coupling of the bracket 130 to the band saw 10. The saw coupling feature(s) 132 may be apertures in the bracket 130, and may accept band saw fastener(s) 134 (e.g., bolts). The band saw fastener(s) 134 may further engage with features at the mounting portion 15 of the band saw 10. Such a feature in the mounting portion 15 may be a hole with complementary threads to a bolt-type band saw fastener 134. An example of this type of band saw fastener 134 and mounting portion 15 is shown in FIG. 8. Another type of feature may be a through-hole through which a band saw fastener 134 may be inserted and secured (e.g., a bolt and a nut). An example of this type of band saw fastener 134 and mounting portion 15 is shown in FIG. 4. The band saw fastener 134 may be different lengths, sizes, and configurations in order to couple the bracket 130 to the mounting portion 15 of the band saw 10.

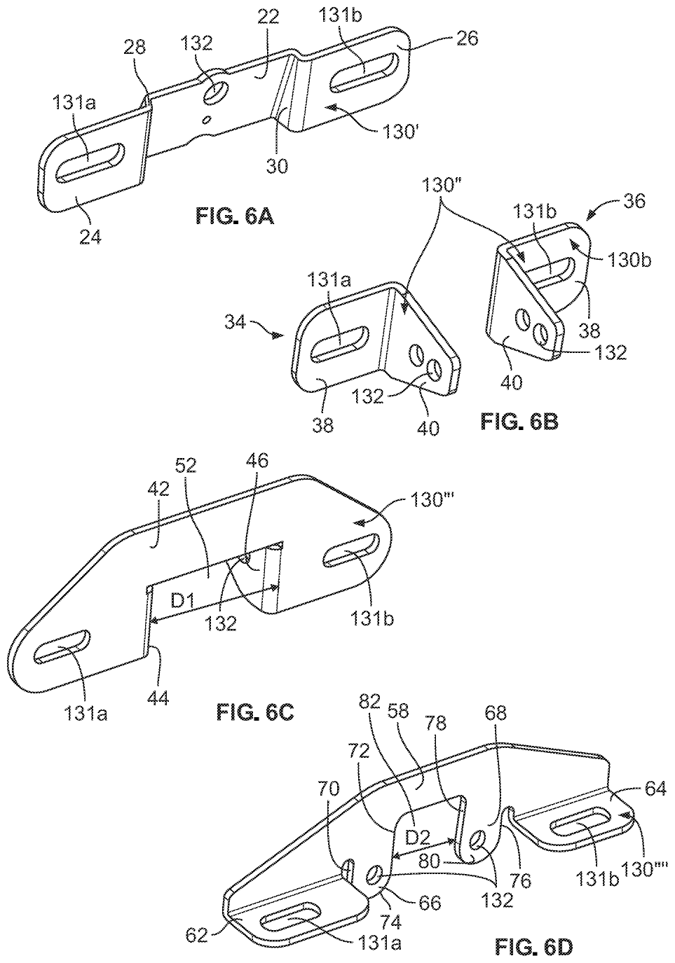

FIGS. 6A, 6B, 6C, and 6D illustrate different embodiments of the bracket 130, specifically, the brackets 130′, 130″, 130″, and 130″, respectively. Each bracket 130 may couple to different types of mounting portions 15 of the band saws 10. The brackets 130 may couple to different types of band saws 10, each having different mounting portions 15. Each bracket 130 depicted in FIGS. 6A-6D have the first arm coupling feature 131a and the second arm coupling feature 131b.

As shown in FIG. 6A, a bracket 130′ includes a center portion 22, a first side portion 24, a second side portion 26, a first sidewall 28, and a second sidewall 30. The center portion 22 includes the saw coupling feature 132. The first side portion 24 includes the first arm coupling feature 131a and the second side portion 26 includes the second arm coupling feature 131b. The first arm coupling feature 131a is generally oval-shaped. The bracket fasteners 133 may be used to securely fasten the first arm coupling feature 131a and the second arm coupling feature 131b to the arm 120. The first side portion 24 and the second side portion 26 are coplanar with each other and vertically displaced from the center portion 22. In the exemplary embodiment, the first side portion 24 and the second side portion 26 are coupled to the upper arm portion 121 of the arm 120 with bracket fasteners 133. The first sidewall 28 and the second sidewall 30 extend from the first side portion 24 and the second side portion 26, respectively, downwardly towards the center portion 22. The center portion 22 extends between the first sidewall 28 and the second sidewall 30. The center portion 22 is coupled to the mounting portion 15 of the band saw 10. The first arm coupling feature 131a and the second arm coupling feature 131b are generally oval-shaped apertures. In alternative embodiments, the first arm coupling feature 131a and the second arm coupling feature 131b may be of different shapes and sizes.

The saw coupling feature 132 on the bracket 130′ shown in FIG. 6A aligns with a mounting receiver 32 located on the mounting portion 15′ permitting the bandsaw fastener 134′ to extend through the saw coupling feature 132 and into the mounting receiver 32. The bandsaw fastener 134′ may securely couple the band saw 10 to the bracket 130′. The mounting receiver 32 may be threaded. The mounting portion 15 may also be adapted to securely couple a handle (not shown) to the bandsaw 10. The handle may be removed from the band saw 10 to expose the mounting receiver 32. In alternative embodiments, the bracket 130′ may be coupled to the band saw 10 with other types of fasteners.

In FIG. 6B, a bracket 130″ includes two pieces, a first L-bracket 34 and a second L-bracket 36. The first L-bracket 34 includes a first arm attachment portion 38 having the first arm coupling feature 131a. The first arm coupling feature 131a is generally oval-shaped. The bracket fasteners 133 may be used to securely fasten the first arm coupling feature 131a and the second arm coupling feature 131b to the arm 120. The first L-bracket 34 also includes a band saw attachment portion 40. The band saw attachment portion 40 includes at least one saw coupling feature 132. In the exemplary embodiment, the band saw attachment portion 40 includes two saw coupling features 132. The band saw attachment portion 40 and the arm attachment portion 38 form a 90 degree angle approximately. In alternative embodiments, the angle formed between the band saw attachment portion 40 and the arm attachment portion 38 may be other angles, greater or less than 90 degrees. The band saw attachment 40 is generally trapezoidal in shape. In alternative embodiments, the band saw attachment 40 may be formed into other shapes. The arm attachment portion 38 is generally rectangular in shape. In alternative embodiments, the arm attachment may be other shapes. The second L-bracket 36 is a mirror image of the first L-bracket 34.

One of the saw coupling features 132 on the first L-bracket 34 aligns with a receiving portion, not shown, located on the mounting portion 15″ permitting a mounting fastener, not shown, to extend through the saw coupling feature 132 and into the mounting receiver. The mounting fastener may securely fasten the band saw 10 to the first L-bracket 34. One of the saw coupling features 132 on the second L-bracket 36 aligns with the mounting receiver on the opposite lateral side of the mounting portion 15″ from which the first L-bracket 34 may be positioned. The mounting fastener may extend from the saw coupling feature 132 of the first L-bracket 34 through the mounting receiver to the saw coupling feature 132 of the second L-bracket 36. The mounting fastener may securely couple the band saw 10 to the bracket 130″. The mounting receiver may be threaded. The same positioned saw coupling feature 132 should be used on the first L-bracket 34 and the second L-bracket 36 when coupling the bracket 130″ to the band saw 10. For example, when the saw coupling feature 132 located furthest away from the arm attachment portion 38 is being used on the first L-bracket 34, then the saw coupling feature 132 located furthest away from the arm attachment portion 38 should be used on the second L-bracket 36. The mounting portion 15″ may also be adapted to securely couple a handle and hook, both not shown, to the band saw 10. The handle and the hook may be removed to expose the mounting receiver location on the mounting portion 15″. In alternative embodiments, the bracket 130″ may be coupled to the band saw 10 with other types of fasteners. Furthermore, in alternative embodiments, one bolt or screw may be used to couple each of the first L-bracket 34 and the second L-bracket 36 to the mounting portion 15″. The bracket 130″ may be mounted to the mounting portion 15″ such that both the arm attachment portions 38 are located above the band saw attachment portions 40 when the bracket 130″ is mounted to the arm 120. The bracket 130″ may also be mounted to the mounting portion 15″ such that both the arm attachment portions 38 are located below the band saw attachment portions 40 when the bracket 130″ is mounted to the arm 120.

In FIG. 6C, a bracket 130″ includes an arm attachment portion 42 generally trapezoidal in shape, a first saw coupling bracket 44, a second saw coupling bracket 46, a top surface 48, and a bottom surface, located on the opposite side of the arm attachment portion 42 from the top surface 48, not shown. The first arm coupling feature 131a and the second arm coupling feature 131b are located on opposite lateral sides of the bracket 130″. The first arm coupling feature 131a and the second arm coupling feature 131b are generally oval-shaped. In alternative embodiments, the first arm coupling feature 131a and the second arm coupling feature 131b may be different shapes. The bracket fasteners 133 may be used to securely fasten the first arm coupling feature 131a and the second arm coupling feature 131b to the arm 120. The first saw coupling bracket 44 and the second saw coupling bracket 46 extend from the arm attachment portion 42 at a 90 degree angle approximately, in the same direction, such that the first saw coupling bracket 44 and the second saw coupling bracket 46 are generally parallel with each other. In alternative embodiments, the first saw coupling bracket 44 and the second saw coupling bracket 46 may extend from the arm attachment portion 42 at different angles. The first saw coupling bracket 44 is located a distance D1 from the second saw coupling bracket 46. A gap 52 is formed on the arm attachment portion 42 at the location where the first saw coupling bracket 44 and the second saw coupling bracket 46 bend and extend away from the attachment portion 42 at approximately 90 degrees. Therefore, the gap 52 is approximately the same distance as D1. In alternative embodiments, the length of the gap 52 may be a different length/distance from D1. The first saw coupling bracket 44 includes one saw coupling feature 132. The second saw coupling bracket 46 includes one saw coupling feature 132. The saw coupling feature 132 on the first saw coupling bracket 44 is aligned with the saw coupling feature 132 on the second saw coupling bracket 46, such that the band saw fastener 134 may be inserted through the saw coupling feature 132 on the first saw coupling bracket 44 and extend through to the saw coupling feature 132 located on the second saw coupling bracket 45 or vice versa.

As shown in FIG. 4, the bracket 130″ from FIG. 6C may be securely fastened to the mounting portion 15′″ of a band saw 10 having a through hole 54. Portions of the bottom surface, not shown, of the arm attachment portion 42 contact the mounting portion 15′″. The bracket 130″ from FIG. 6C mounts on the mounting portion 15″ such that the first saw coupling bracket 44 is located on one side of the mounting portion 15′″ and the second saw coupling bracket 46 is located on the second or opposite side of the mounting portion 15′″. The saw coupling features 132 of both the first saw coupling bracket 44 and the second saw coupling bracket 46 are aligned with the through hole 54 on the respective sides of the mounting portion 15′″. The alignment between the saw coupling features 132 and the through hole 54 enable the band saw fastener 134 to extend from the saw coupling feature 132 on the first saw coupling bracket 44 through to the saw coupling feature 132 on the second saw coupling bracket 46. The band saw fastener 134 passes through the mounting portion 15′″ between the saw coupling feature 132 on the first saw coupling bracket 44 and the saw coupling feature 132 on the second saw coupling bracket 46. A nut 56 may be coupled to the band saw fastener 134 on the side of the second saw coupling bracket 46 to securely fasten the bracket 130″ to the band saw 10. In alternative embodiments, the band saw fastener 134 may extend through the first saw coupling bracket 44 and the second saw coupling bracket 46 and the mounting portion 15″, such that the nut 56 may be coupled to the band saw fastener 134 on the side of the first saw coupling bracket 44. Furthermore, alternative embodiments may include different types of fasteners to securely fasten the bracket 130′″ to the mounting portion 15″.

In FIG. 6D, a bracket 130″″ includes a front surface 58, a back surface (not shown), a first arm attachment portion 62, a second arm attachment portion 64. The first arm attachment portion 62 and the second arm attachment portion 64 extend from the front surface 58 of the bracket 130″″ at a 90 degree angle approximately. The first arm attachment portion 62 and the second arm attachment portion 64 extend away from the front surface 58 in the same direction. The first arm attachment portion 62 and the second arm attachment portion 64 extend from the front surface 58 on opposing sides of the front surface 58 of the bracket 130″″. The first arm attachment portion 62 includes the first arm coupling feature 131a and the second arm attachment portion 64 includes the second arm coupling feature 131b. The bracket fasteners 133 may be used to securely fasten the first arm coupling feature 131a and the second arm coupling feature 131b to the arm 120. The first arm coupling feature 131a and the second arm coupling feature 131b are generally oval-shaped. In alternative embodiments, the first arm attachment portion 62 and the second arm attachment portion 64 may extend from the front surface 58 in different angles, greater or less than 90 degrees. Additionally, in alternative embodiments, the first arm coupling feature 131a and the second arm coupling feature 131b may be in the form of other shapes.

As shown in FIG. 6D, the front surface 58 of the bracket 130″″ includes a first saw coupling extension 66 and a second saw coupling extension 68. The first saw coupling extension 66 includes an exterior surface 70, an interior surface 72, a curved ending 74, and the saw coupling feature 132. The second saw coupling extension 68 includes an exterior surface 76, an interior surface 78, a curved ending 80, and the saw coupling feature 132. The curved ending 74 on the first saw coupling extension 66 and the curved ending 80 on the second saw coupling extension 68 extend downwardly, beyond the first arm attachment portion 62 and the second arm attachment portion 64, respectively. The first arm attachment portion 62 and the second arm attachment portion 64 are vertically displaced from the first saw coupling extension 66 and the second saw coupling extension 68, respectively, when the bracket 130″″ is securely fastened to the band saw 10. The interior surface 72 of the first saw coupling extension 66 and the interior surface 78 of the second saw coupling extension 68 are separated by a distance D2 forming a gap 82. The gap 82 is sized to receive the mounting portion 15″″ of the band saw 10.

As shown in FIG. 8, the bracket 130″″ from FIG. 6D may be securely fastened to the mounting portion 15″″ of the band saw 10 having a first fastener receiver (not shown) and a second fastener receiver (not shown) located near a top portion of the mounting portion 15′″. The saw coupling feature 132 on the first saw coupling extension 66 aligns with the first fastener receiver. The saw coupling feature 132 on the second saw coupling extension 68 aligns with the second fastener receiver. A mounting fastener 88 may be inserted through the saw coupling feature 132 on the first saw coupling extension 66 and inserted into the first fastener receiver. Another mounting fastener 88 may be inserted through the saw coupling feature 132 on the second saw coupling extension 68 and inserted through into the second fastener receiver. The mounting fasteners 88 may securely mount the bracket 130″″ to the mounting portion 15″″ of the band saw 10. The mounting fasteners 88 may be bolts, but other types of fasteners may be used that may securely couple the bracket 130″″ to the band saw 10.

As shown in FIG. 8, the first arm attachment portion 62 may be securely fastened to the arm 120 by aligning the first arm coupling feature 131a over the second engagement feature 123 and inserting the bracket fastener 133 through the first arm attachment portion 62 and the second engagement feature 123 and securing the bracket fastener 133 with the nut, not shown. The second arm attachment portion 64 may be securely fastened to the arm 120 by aligning the second arm coupling feature 131b over the first engagement feature 122 and inserting the bracket fastener 133 through the second arm attachment portion 62 and the first engagement feature 122 and securing the bracket fastener 133 with the nut, not shown. In the exemplary embodiment, the bracket fastener 133 used is a bolt and nut arrangement. In alternative embodiments, other types of bracket fasteners 133 may be used to secure the bracket 130″″ to the arm 120.

In FIGS. 6A, 6B, 6C, and 6D, the saw coupling features 132 may receive the same type of band saw fasteners 134 or different band saw fasteners. Additionally, the first arm coupling feature 131a and the second arm coupling feature 131b may be configured to receive the same bracket fasteners 133. In alternative embodiments, the first arm coupling feature 131a and the second arm coupling feature 131b may be configured to receive different types and lengths of bracket fasteners 133. Each bracket, 130′, 130″, 130″, and 130″ may receive differently configured mounting portions 15. Different types of brands, models, and configurations of bands saws 10 may have different mounting portions 15 capable of being coupled to the brackets 130′, 130″, 130″, and/or 130″″.

Turning back to FIGS. 2A, 2B, and 3 (and particularly FIGS. 2A and 2B), there are a plurality of trigger coupling feature(s) 124 located on the upper arm portion 121 of the arm 120. A trigger bar 140 includes a first trigger bar end 141 and a second trigger bar end 142. The first trigger bar end 141 may be coupled to any of the trigger coupling features 124. The operator selects the specific trigger coupling feature(s) 124 to couple the first trigger bar end 141 of the trigger bar 140 based on the configuration of the band saw 10 being inserted through the arm 120 of the band saw stand 100. The operator may also select the specific trigger coupling feature(s) 124 to couple the first trigger bar end 141 of the trigger bar 140 based on the preference of the operator. By coupling the trigger bar 140 to different ones of the trigger coupling features 124, the trigger bar 140 can be oriented at different angles with respect to the arm 120. The angle of the trigger bar 140 may be adjusted to effectively engage with different band saw triggers 11 on different models, brands, or configurations of band saws 10. The trigger bar 140 may be coupled to one of the trigger coupling feature(s) 124 with a trigger fastener 143, such as a bolt or screw.

The trigger bar 140 may be able to rotate or pivot about the trigger fastener 143 to effect engagement and disengagement of the band saw trigger 11. The second trigger bar end 142 of the trigger bar 140 may be received by a trigger slot 128. The trigger bar slot 128 is located along a portion of the upper arm portion 121 on the opposing side of the arm 120 from the trigger coupling features 124. The trigger bar 140 may move freely through the trigger slot 128. A trigger bar switch 210 may be coupled to the arm 120 and may push the trigger bar 140 away from the handle 127, thereby engaging the band saw trigger 11. When the operator pushes the trigger bar switch 210 away from the handle 127, it may cause the band saw 10 to activate and the blade 14 to spin. The blade 14 will continue to spin as long as the operator is applying pressure to the trigger bar switch 210. When the trigger bar switch 210 is released, the spring action of the band saw trigger 11 may force the trigger bar 140 and the trigger bar switch 210 outwardly to non-operational positions. Further, a spring may be provided (not shown) that automatically returns the trigger bar switch 210 to its non-operational position. This may further cause the band saw trigger 11 to become disengaged. The trigger bar switch 210 may extend through the trigger slot 128. In alternative embodiments, the operator may not have to continuously apply pressure to the trigger bar switch 210 to keep the blade 14 spinning on the band saw 10.

Opposing stabilizers 160 may be received by the arm 120 on opposite lateral sides of the arm 120. At one end of a given stabilizer 160 is a knob 162, and at the other end is a foot 161. The knob 162 and foot 161 may be coupled by a shaft 163. The knob 162 and foot 161 may not be rotationally coupled, such that when the knob 162 is turned, the foot 161 may not turn. The shaft 163 may be threaded and may extend through complementary threads in an aperture in the lateral side of the arm 120. The shaft may be rotationally coupled with the knob 162, such that turning the knob 162 causes the shaft to advance inwardly (e.g., clockwise rotation) towards the other stabilizer 160 or outwardly (e.g., counterclockwise rotation) away from the other stabilizer 160. When the opposing stabilizers 160 are complimentarily advanced inwards, the corresponding feet 161 engage the band saw 10, thereby stabilizing the position of a rear location of the band saw 10. The feet 161 may comprise rubber or compressible plastic to frictionally engage with the band saw 10, thereby stabilizing the band saw 10 in the band saw stand 100.

As shown in FIG. 5, the band saw stand 100 may further include a table plate 6 that mounts to the band saw 10. A guide bar 8 (see FIG. 4) may be removed from the band saw 10 and the table plate 6 may be installed in place of the guide bar 8. When the band saw stand 100 is arranged in its vertical orientation, the table plate is substantially parallel to the horizontal surface 20. The blade 14 may extend into a slot in the table plate. The operator may rest a work piece on the table plate to control cutting with the blade 14.

PARTS LIST

| | |
|---|---|
| 10 | Band saw |
| 11 | Band saw trigger |
| 12 | Front wheel case |
| 13 | Rear wheel case |
| 14 | Blade |
| 15 | Mounting portion |
| 16 | Band saw opening |
| 18 | Back plate |
| 20 | Surface |
| 22 | Center portion |
| 24 | First side portion |
| 26 | Second side portion |
| 28 | First sidewall |
| 30 | Second sidewall |
| 32 | Mounting receiver |
| 34 | First L-bracket |
| 36 | Second L-bracket |
| 38 | Arm attachment portion for 130″ |
| 40 | Band saw attachment portion |
| 42 | Arm attachment portion for 130″′ |
| 44 | First saw coupling bracket |
| 46 | Second saw coupling bracket |
| 48 | Top surface |
| 50 | Bottom surface |
| 52 | Gap |
| 54 | Through hole |
| 56 | Nut |
| 58 | Front surface |
| 60 | Back surface |
| 62 | First arm attachment portion |
| 64 | Second arm attachment portion |
| 66 | First saw coupling extension |
| 68 | Second saw coupling extension |
| 70 | Exterior surface of 66 |
| 72 | Interior surface of 66 |
| 74 | Curved ending of 66 |
| 76 | Exterior surface of 68 |
| 78 | Interior surface of 68 |
| 80 | Curved ending of 68 |
| 82 | Gap |
| 88 | Mounting fasteners |
| 100 | Band saw stand |
| 110 | Base |
| 111 | Fence coupling feature |
| 112 | Strut coupling feature |
| 113 | Front wheel cutout |
| 114 | Rear wheel cutout |
| 115 | Fence angle markings |
| 116 | Clamp engagement feature |
| 117 | Base aperture |
| 120 | Arm |
| 121 | Upper portion of arm |
| 122 | First engagement feature |
| 123 | Second engagement feature |
| 124 | Trigger coupling feature |
| 125 | Strut coupling feature |
| 126 | Mounting holes |
| 127 | Handle |
| 128 | Trigger slot |
| 129 | Arm aperture |
| 130 | Bracket |
| 130′ | Bracket shown in FIG. 6A |
| 130″ | Bracket shown in FIG. 6B |
| 130″′ | Bracket shown in FIG. 6C |
| 130″″ | Bracket shown in FIG. 6D |
| 131 | Arm coupling feature |
| 132 | Saw coupling feature |
| 133 | Bracket fastener |
| 134 | Band saw fastener |
| 140 | Trigger bar |
| 141 | First end of trigger bar |
| 142 | Second end of trigger bar |
| 143 | Fastener |
| 150 | Fence |
| 151 | Pivot |
| 152 | Fence adjustment slot |
| 160 | Stabilizer |
| 161 | Foot |
| 162 | Knob |
| 163 | Shaft |
| 180 | Strut |
| 181 | Strut first end |
| 182 | Strut second end |
| 190 | Coupling plate |
| 191 | Base fastener |
| 192 | Coupling plate aperture |
| 193 | Lateral aperture |
| 194 | Arm fastener |
| 200 | Lock |
| 210 | Trigger bar switch |
| 220 | Fence tightener |

What is claimed:

1. A band saw stand comprising:
a base; and
an arm rotatably coupled to the base, wherein the arm defines an opening configured to receive a selected one of at least a mounting portion of a first band saw and a mounting portion of a second band saw, wherein the mounting portion of the first band saw and the mounting portion of the second band saw are different,
wherein the band saw stand is configured to couple to the selected one of at least the mounting portion of the first band saw and the mounting portion of the second band saw.

2. The band saw stand of claim 1, wherein the base is configured to be selectively operable in a horizontal orientation and a vertical orientation.

3. The band saw stand of claim 1, further comprising a first bracket configured to couple to the arm and configured to move with respect to the arm, wherein the first bracket is configured to couple to the mounting portion of the first band saw.

4. The band saw of claim 3, further comprising a second bracket configured to couple to the arm and configured to move with respect to the arm, wherein the second bracket is configured to couple to the mounting portion of the second band saw.

5. The band saw stand of claim 1, further comprising a trigger bar coupled to the arm, wherein the trigger bar is adjustable into at least a first orientation and a second orientation.

6. The band saw stand of claim 1, further comprising an adjustable fence configured to adjust a cut angle and movably coupled to the base.

7. The band saw of claim 1, further comprising a strut coupled to the arm and the base, wherein one end of the strut is movable into a plurality of locations to adjust an angle of the strut with respect to the base.

8. A band saw stand comprising:
a base configured to mount to a surface;
an arm rotatably coupled to the base, wherein the arm includes an upper portion defining a length and a width, wherein the upper portion includes at least one engagement feature, wherein the upper portion defines an opening sized to receive portions of different band saws, wherein the band saws have different mounting portions; and
a bracket configured to couple with the arm and move with respect to the arm via the at least one engagement feature, wherein the bracket is configured to couple to the mounting portion of at least one of the band saws.

9. The band saw stand of claim 8, wherein the base is configured to be operable in a horizontal orientation and a vertical orientation.

10. The band saw stand of claim 8, wherein the at least one engagement feature of the arm includes at least one aperture extending along the length dimension of the upper portion of the arm, wherein the bracket is securable to the upper portion of the arm via the at least one engagement feature at a plurality of locations along the length of the at least one aperture.

11. The band saw stand of claim 8, further comprising a plurality of brackets, wherein each bracket is configured to couple to different mounting portions of the band saws.

12. The band saw stand of claim 8, further comprising a trigger bar coupled to the upper portion of the arm, wherein the trigger bar is configured to be adjustable in a plurality of positions to interact with triggers of the band saws.

13. The band saw stand of claim 8, further comprising an adjustable fence configured to adjust a cut angle and movably coupled to the base.

14. The band saw of claim 8, further comprising a strut coupled to the arm and the base, wherein one end of the strut is movable into a plurality of locations to adjust an angle of the strut with respect to the base.

15. A band saw stand comprising:
a base; and
an arm rotatably coupled to the base, wherein the arm includes a mounting plate, wherein the arm includes an opening to receive a portable band saw,
wherein the band saw stand is configurable in a horizontal orientation when the base is resting on a horizontal surface, and
wherein the band saw stand is configurable in a vertical orientation when mounting plate is fastened to a horizontal surface.

16. The band saw stand of claim 15, further comprising a first bracket configured to couple to the arm and configured to move with respect to the arm, wherein the first bracket is configured to couple to a mounting portion of a first band saw.

17. The band saw of claim 16, further comprising a second bracket configured to couple to the arm and configured to move with respect to the arm, wherein the second bracket is configured to couple to a different mounting portion of a second band saw.

18. The band saw stand of claim 15, further comprising a trigger bar coupled to the arm, wherein the trigger bar is adjustable into at least a first orientation and a second orientation.

19. The band saw stand of claim 15, further comprising a table plate configured to couple to the arm.

20. The band saw of claim 15, further comprising a strut coupled to the arm and the base, wherein one end of the strut is movable into a plurality of locations to adjust an angle of the strut with respect to the base.
